(19) United States
(12) Patent Application Publication
(10) Pub. No.: US 2026/0087277 A1
(43) Pub. Date: Mar. 26, 2026

(54) ELECTRONIC GAMING DEVICE TRACKING SYSTEM AND METHOD

(71) Applicant: Aristocrat Technologies, Inc., Las Vegas, NV (US)

(72) Inventors: Robert Butler, Austin, TX (US); Jason Byrne, Austin, TX (US); Jeannie Chiem, Georgetown, TX (US)

(21) Appl. No.: 18/897,821

(22) Filed: Sep. 26, 2024

(51) Int. Cl. G06K 7/10; G06T 7/70

(52) U.S. Cl. CPC G06K 7/10099; G06T 7/70

(57) ABSTRACT

A device management system is provided. The device management system may include at least one gaming device including at least one sub-component and an RFID reader configured to detect at least one RFID identifier of at least one RFID tag disposed on the sub-component AND a host system configured to: (1) receive device data from the gaming device, the device data identifying the detected RFID identifier; (2) perform a lookup to identify the sub-component based on the detected RFID identifier; (3) determine a real-time location of the gaming device using a real-time locating system; (4) determine a location of the sub-component based on the determined real-time location of the gaming device; and (5) generate a map including the location of the gaming device and of the sub-component.

### TECHNICAL FIELD

The field of this disclosure relates generally to electronic gaming, and more specifically, to systems and methods for electronically tracking electronic gaming devices and components thereof.

### BACKGROUND

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

Some known gaming devices may also use historical horse racing results (e.g., or other historical data) to determine wagering game outcomes. In some known systems, it may be desired and/or required for at least a portion of a historical event associated with the historical data to be displayed. Thus, according to some known systems, if a display device configured to display historical event malfunctions or is otherwise inoperable, a gaming device associated with that display device may be required to shut down until that display device is fixed or replaced (e.g., because until the display device is fixed, the historical event(s) desired/required to be displayed as part of an electronic game will not be displayed). Accordingly, systems and methods are desired for dynamic monitor detection in electronic gaming such that if an initial display device becomes inoperable, data is automatically displayed on a different display device instead of requiring a shutdown of the gaming device until the initial display device is fixed and/or replaced.

### BRIEF DESCRIPTION

In one aspect, a device management system is provided. The device management system may include at least one gaming device including at least one sub-component and a radio frequency identification (RFID) reader configured to detect at least one RFID identifier of at least one RFID tag disposed on the at least one sub-component. The device management system may further include a host system including a real-time locating system and at least one processor in communication with the at least one gaming device, with the real-time locating system, and with at least one memory device. The at least one processor may be configured to: (1) receive device data from the at least one gaming device, the device data identifying the detected at least one RFID identifier; (2) perform a lookup to identify the at least one sub-component based on the detected at least one RFID identifier; (3) determine a real-time location of the at least one gaming device using the real-time locating system; (4) determine a location of the at least one sub-component based on the determined real-time location of the at least one gaming device; and (5) generate a map including the real-time location of the at least one gaming device and the location of the at least one sub-component.

In another aspect, a host system for a device management system may be provided. The host system may include a real-time locating system and at least one processor in communication with at least one memory device, the real-time locating system, and at least one gaming device. The at least one gaming device may include at least one sub-component and an RFID reader configured to detect at least one RFID identifier of at least one RFID tag disposed on the at least one sub-component. The at least one processor may be configured to: (1) receive device data from the at least one gaming device, the device data identifying the detected at least one RFID identifier; (2) perform a lookup to identify the at least one sub-component based on the detected at least one RFID identifier; (3) determine a real-time location of the at least one gaming device using the real-time locating system; (4) determine a location of the at least one sub-component based on the determined real-time location of the at least one gaming device; and (5) generate a map including the real-time location of the at least one gaming device and the location of the at least one sub-component.

In another aspect, a method for device management may be provided. The method may be performed by a host system including a real-time locating system and at least one processor in communication with at least one memory device, the real-time locating system, and at least one gaming device. The at least one gaming device may include at least one sub-component and an RFID reader configured to detect at least one RFID identifier of at least one RFID tag disposed on the at least one sub-component. The method may include (1) receiving device data from the at least one gaming device, the device data identifying the detected at least one RFID identifier; (2) performing a lookup to identify the at least one sub-component based on the detected at least one RFID identifier; (3) determining a real-time location of the at least one gaming device using the real-time locating system; (4) determining a location of the at least one sub-component based on the determined real-time location of the at least one gaming device; and (5) generating a map including the real-time location of the at least one gaming device and the location of the at least one sub-component.

### BRIEF DESCRIPTION OF THE DRAWINGS

FIG. 1 illustrates several different models of EGMs which maybe be networked to various gaming related servers in an example embodiment.

FIG. 2A is a block diagram depicting various functional elements of an EGM in an example embodiment.

FIG. 2B depicts a casino gaming environment in an example embodiment.

FIG. 2C is a diagram of components of a system for providing online gaming in an example embodiment.

FIG. 3 illustrates, in block diagram form, an implementation of a game processing architecture algorithm that implements a game processing pipeline for the play of a game in accordance with various implementations described herein.

FIG. 4 is a block diagram illustrating an exemplary gaming device according to an exemplary embodiment of the present disclosure.

FIG. 5 is a block diagram illustrating an exemplary device management system according to an exemplary embodiment of the present disclosure that may include the gaming device shown in FIG. 4.

FIG. 6 is a block diagram illustrating another exemplary device management system according to an exemplary embodiment of the present disclosure that may include the gaming device shown in FIG. 4.

FIG. 7 illustrates an exemplary arrangement of cameras with respect to a visual tag according to an exemplary embodiment of the present disclosure.

FIG. 8A is an example image of the visual tag shown in FIG. 7 as viewed from a first camera.

FIG. 8B is an example image of the visual tag shown in FIG. 7 as viewed from a second camera.

FIG. 9 depicts an exemplary user interface according to an exemplary embodiment of the present disclosure.

FIG. 10 is a flowchart illustrating an exemplary method for device management according to an exemplary embodiment of the present disclosure that may be performed by the device management systems shown in FIGS. 5 and 6.

### DETAILED DESCRIPTION

The systems and methods described herein include systems and methods for electronically tracking electronic gaming devices and components thereof. In exemplary embodiments, the systems and methods described herein device management system that is capable of determining a location of gaming devices within a gaming environment and further determining a location of sub-components of these gaming devices (e.g., components that may be removed from or transferred between gaming devices) using a combination of communication technologies. These systems and methods utilize a two-tier approach, in which a short-range locating technique such as radio frequency identification (RFID) is used to identify sub-components that are installed on or within a gaming device and a longer-range and/or real-time locating technique (e.g., utilizing cameras and/or a wireless mesh network) is used to determine a real-time location of the gaming device that includes the sub-components.

As used herein, “short-range” wireless technology refers to wireless technology including a first preconfigured device, sometimes referred to herein a “reader,” that capable of wirelessly detecting a presence of one or more second preconfigured devices, sometimes referred to herein as “tags,” within a predefined detection range without determining a specific location of the tag with respect to the reader or to a predefined coordinate system. The tags do not necessarily need to be within a line of sight of the reader to be detected by the reader.

The device management system may include at least one gaming device (e.g., an EGM) that includes at least one sub-component. The sub-component may include, for example, a cash box, a cabinet base, or another component that is removable or separable from the gaming device. The gaming device and sub-components may each be associated with a corresponding identifier. For example, the gaming device may be associated with a unique identifier referred to herein as a “gaming device identifier,” and the sub-component may each include an RFID tag that provides an RFID identifier associated with the sub-component. The gaming device may include an RFID reader that is configured to detect the RFID identifier of the RFID tag disposed on any of the sub-components installed on or within the gaming device. For example, the RFID tags may include passive or active circuits that output an electromagnetic signal detectable by the RFID reader that includes the RFID identifier in response to receiving a first electromagnetic signal from the RFID reader.

The device management system may further include a host system that includes a real-time locating system and at least one host processor in communication with the gaming device, with the real-time locating system, and with at least one memory device. The host processor may be configured to receive device data from the gaming device. The device data may include, for example, the gaming device identifier associated with the gaming device and the RFID identifiers of any sub-components detected by the RFID reader of the gaming device. The host processor may perform a lookup to identify the sub-component based on the detected at least one RFID identifier. Based on this information, the host processor is capable of determining which sub-components are installed at which gaming devices.

The host processor may further be configured to determine a real-time location of the gaming device using the real-time locating system. For example, in some embodiments, the real-time locating system may include a wireless mesh network, such as a Bluetooth low energy (BLE) or ultra wide band (UWB) network, which the host processor may use to determine a location of the gaming device. In such embodiments, the host processor may be in communication with one or more gateways, and each gaming device may include a beacon configured to communicate wirelessly with the gateways such that the gateways and beacons form a mesh network. As described in further detail below, the mesh network may enable various techniques, such as triangulation, trilateration, or received signal strength indicator (RSSI), to be utilized by the host processor to determine the location of the gaming device.

In another example, in some embodiments, the real-time locating system may include one or more cameras in communication with the host processor, and the gaming device may include a visual tag. In such embodiments, the host system may be capable of identifying and determining a location of the gaming device utilizing computer vision (CV) techniques based on image data received form the one or more cameras. For example, the visual tags may include the gaming device identifier associated with the gaming device and patterns or other features that enable the host processor to determine a position and orientation of the gaming device with respect to the camera from which the image data was received. Because the camera may have a known location, a location of the at least gaming device may be determined based on its position relative to the camera.

The host processor may be further configured to determine a location of the sub-component based on the determined location of the gaming device. Because the host processor can determine which sub-components are installed in a particular gaming device as described above, the host processor may determine that any sub-components installed with in the gaming device are at the same location as the gaming device.

This provides a technical advantage, in that certain types of sub-components, such as cash boxes, may be transferred from one gaming device to another. RFID tags may enable a gaming device to determine that certain sub-components are located within the gaming device. However, RFID tags, while inexpensive, generally do not have sufficient range to enable tracking within a relatively large venue such as a casino. Additionally, RFID and similar short-range technologies generally are capable of determining whether a tag is within a certain detection range, and are not generally capable of determining a precise or real-time location of a tag (e.g., defined by a coordinate system) within a larger environment. Thus, RFID may be sufficient for determining which sub-components are located within the gaming device, but not for determining a location of the sub-components within a larger environment on its own.

In contrast, real-time locating systems generally require that any tracked components either include wireless communication hardware or to be within a range of view of cameras. However, the sub-components described herein may be two small or numerous to easily be equipped with wireless hardware, may not include power supplies or electronics capable of supporting wireless communication hardware, and may be installed (e.g., within a gaming device) where they cannot be detected by cameras. Thus, each approach on its own faces technical challenges when be used to determine locations of both gaming devices and sub-components, while using a combination of RFID and real-time location tracking overcomes these challenges.

For example, because the system described herein enables sub-components to be tracked via their association with a gaming device, when locations of the gaming devices are determined via real-time locating techniques, a global position of the sub-components can be determined while only requiring installation of a cheap-to-implement, low or no power consumption, and/or short-range system such as RFID on the sub-components themselves. For example, a passive RFID tag, which can be powered by an external source such as electromagnetic signals received from the RFID reader, may be attached to the sub-components.

The host processor may further be configured to generate a map or list including the determined locations of the gaming device and the sub-component. In some embodiments, the host processor may be in communication with a user device and may cause the user device to display the generated map or list via an application (e.g., a mobile app or web-based application). In some embodiments, the host processor may further be capable of determining a location of the user device. This may enable, for example, an operator to input a target device into the application and for the application to provide step-by-step directions to the target gaming device or sub-component, to indicate when the user device is near the target gaming device or sub-component, to provide information about nearby gaming devices or sub-components (e.g., identification or determine current status), and/or to cause changes in lighting or display of the target gaming device (e.g., illuminating indicator LEDs) for easy identification. In cases where the user device is associated with a player, detection of the location of the user device may also be utilized for player tracking or promotion, for example, by enabling the host system to identify when the player is located at a particular gaming device and/or causing the user device or gaming device to display (e.g., promotional) messages based on a proximity of the user device to a particular gaming device.

Technical features or enhancements of the systems and methods described herein that enable systems and methods to provide the technical benefits described above may include: (1) enabling a host system to determine a location of gaming devices and removable sub-components of the gaming devices without needing to determine a real-time location of the sub-components by configuring the gaming devices to identify sub-components installed within the gaming device by detecting RFID identifiers or other identifiers detectable using short-range communication, receiving the detected identifiers from the gaming devices, and determining a location of the gaming devices using a wireless mesh network or CV; (2) reducing a cost of locating removable sub-components of a gaming device by detecting RFID identifiers (e.g., from passive RFID tags) or other identifiers detectable using short-range communication, receiving the detected identifiers from the gaming devices, and determining a location of the gaming devices using a wireless mesh network or CV; (3) enabling a host system to generate a user interface including a map or list including locations of gaming devices and removable sub-components of the gaming devices by configuring the gaming devices to identify sub-components installed within the gaming device by detecting RFID identifiers or other identifiers detectable using short-range communication, receiving the detected identifiers from the gaming devices, and determining a location of the gaming devices using a wireless mesh network or CV; and/or (4) enabling a host system to determine a user device is located in proximity to a gaming device or sub-component by comparing a determined location of the user device to a location of the gaming device or sub-component determined as described above.

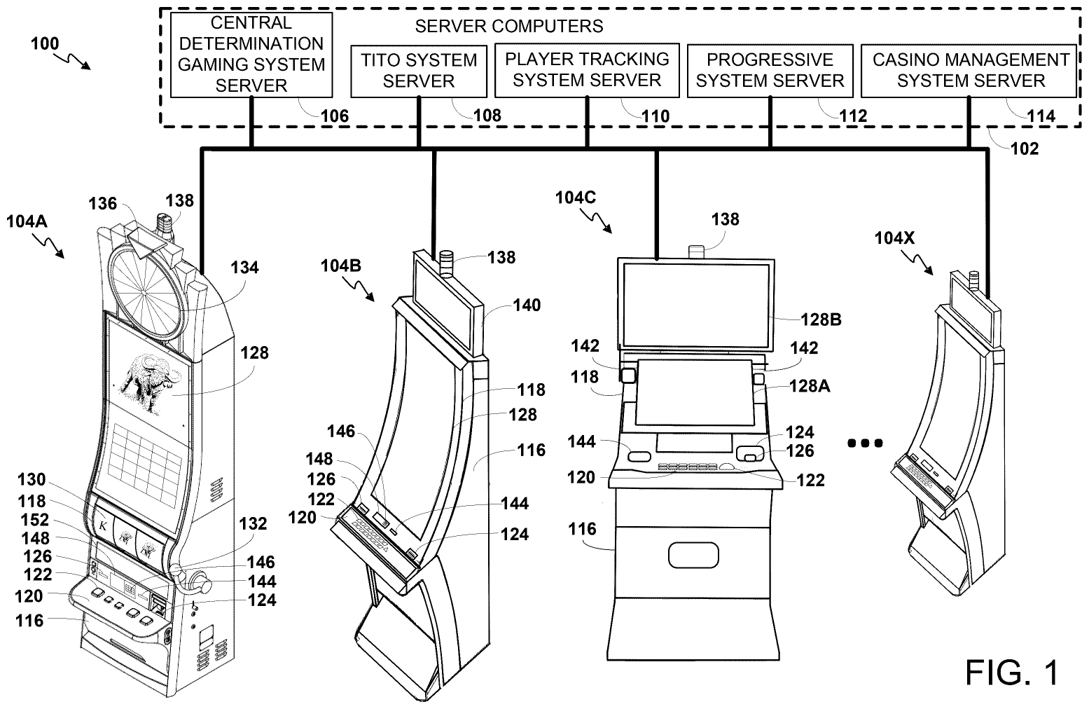

FIG. 1 illustrates several different models of EGMs which may be networked to various gaming related servers in an example embodiment. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

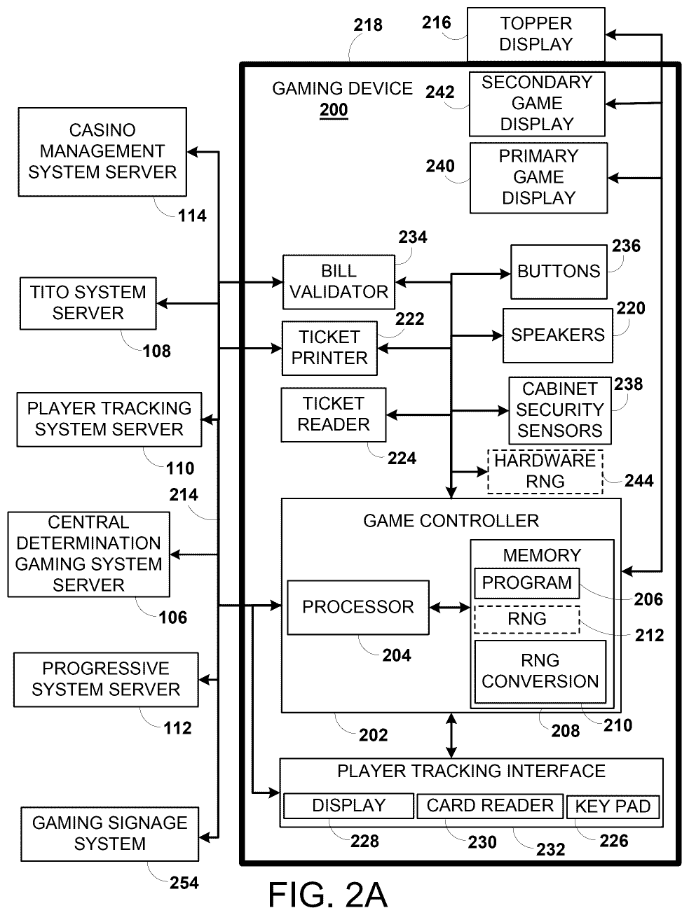

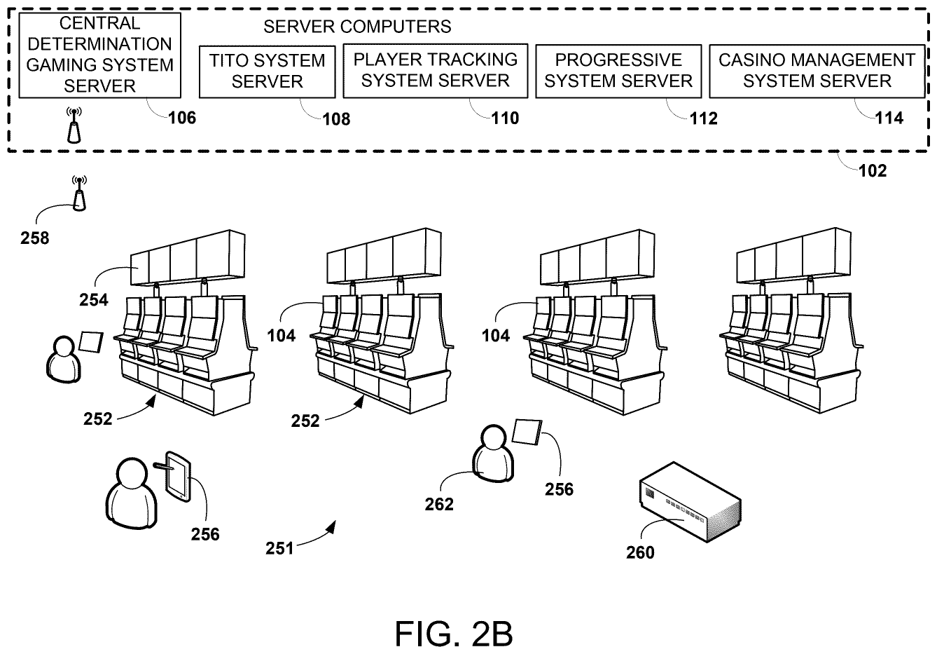

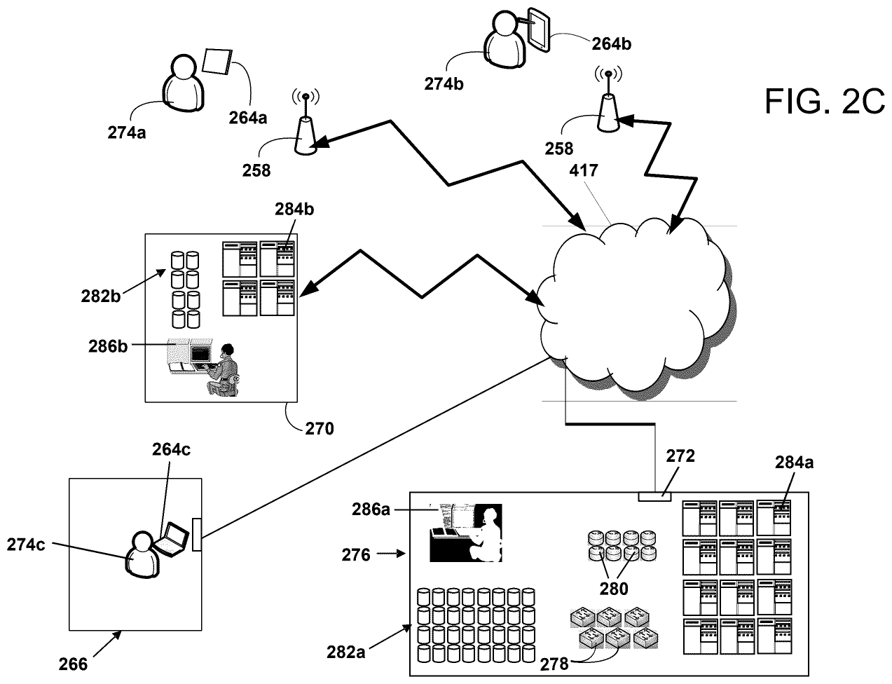

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting various functional elements of a gaming device 200 (e.g., an EGM) in an example embodiment. All or parts of gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment in an example embodiment. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram of components of a system for providing online gaming in an example embodiment. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

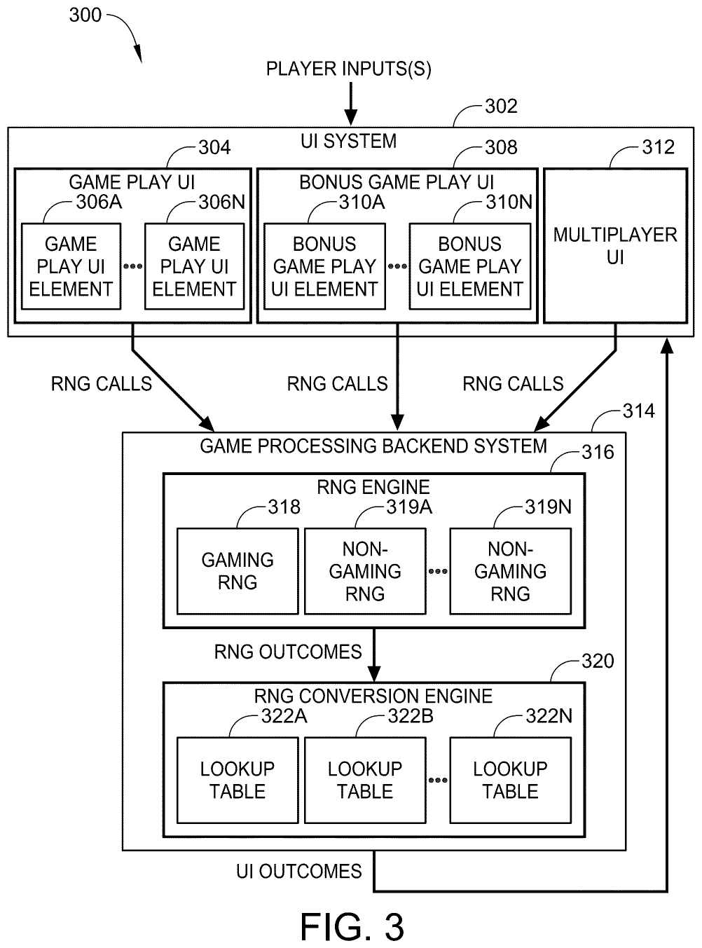

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

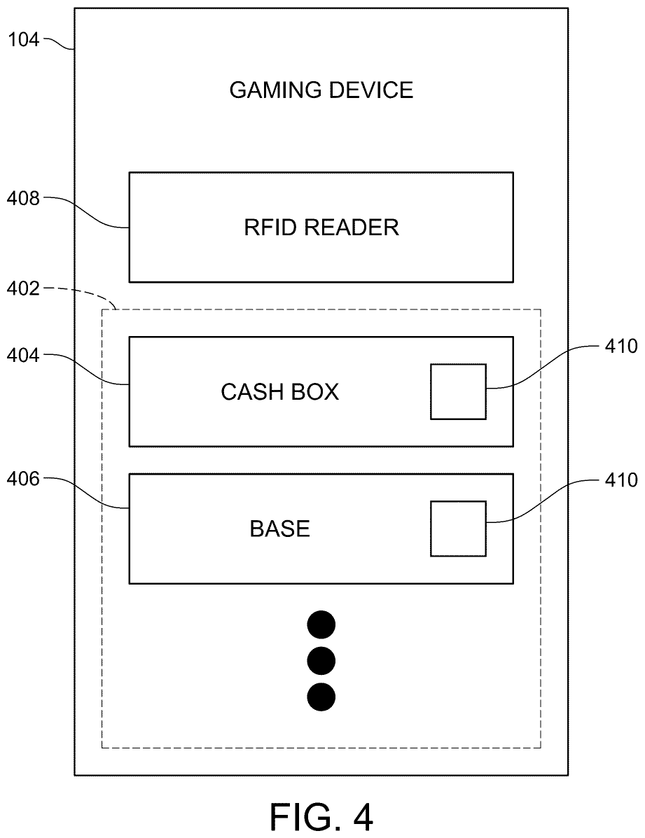

FIG. 4 is a block diagram of an exemplary gaming device 104 that may include one or more sub-components 402. Sub-components 402 may include components that are removable or separable from gaming device 104 such as, for example, a cash box 404 and/or a base 406. While cash box 404 and/or base 406 are depicted as example, in exemplary embodiments, gaming device 104 may include fewer or additional sub-components 402.

Gaming device 104 may further include an RFID reader 408 located locally to (e.g., within) gaming device 104, and each sub-component 402 may include a respective RFID tag 410. In some embodiments, gaming device 104 itself may include a respective RFID tag 410. RFID tags 410 may include passive or active electric circuits capable of generating and transmitting a corresponding RFID identifier. RFID reader 408 may be configured to detect the RFID identifiers generated by RFID tags 410 located within a predefined range, such as on within an enclosure of gaming device 104 itself. Generally, a detection of an RFID tag 410 by RFID reader 408 indicates a presence of the corresponding sub-component 402 within the detection range (e.g., within gaming device 104), and does not necessarily indicate a precise or real-time location of the RFID tag 410 (e.g., with respect to a coordinate system or the like).

For example, in embodiments in which one or more of RFID tags 410 are passive devices, RFID reader 408 may generate and transmit a first RF signal that, when received by passive RFID tags 410, causes RFID tags 410 to generate and transmit their respective RFID identifiers, which may be detected by RFID reader 408. Utilizing passive devices for RFID tags 410 provides the advantages of lowering cost and eliminating a need for RFID tags 410 to include or be coupled to a power source. In embodiments in which one or more of RFID tags 410 are active devices, the active RFID tags 410 may include or be coupled to a power source that enables RFID tags 410 to independently and continuously generate and transmit corresponding RFID identifiers, which may be detected by RFID reader 408. Utilizing active devices for RFID tags 410 provides the advantage of an increased range. In some embodiments, a combination of passive and active RFID tags 410 may be used among sub-components 402.

RFID reader 408 may be configured to store any detected RFID identifiers locally (e.g., within memory 208 shown in FIG. 2A) and/or to transmit the detected RFID identifiers to external host or mapping system, as described in further detail below. RFID reader 408 may be implemented as a stand-alone hardware component (e.g., with a dedicated processor), or may be at least partially integrated into other components of gaming device 104. For example, in some embodiments, certain processing functions of RFID reader 408 may be executed by processor 204 (shown in FIG. 2A). While described with respect to RFID technology, in some embodiments, other forms of short-range wireless technology (e.g., near field communication technology) may be used in combination with or alternatively to RFID technology to identify and determine which sub-components 402 are located within gaming device 104. As described above with respect to RFID, any of these forms of short-range wireless technology may identify a presence of a tagged item within a detection range, and do not necessarily need to identify a precise or real-time location of the tagged item (e.g., with respect to a coordinate system). For example, RFID reader 408 can be located at a cabinet door of gaming device 104 and does not need to be in a line of sight of RFID tags 410.

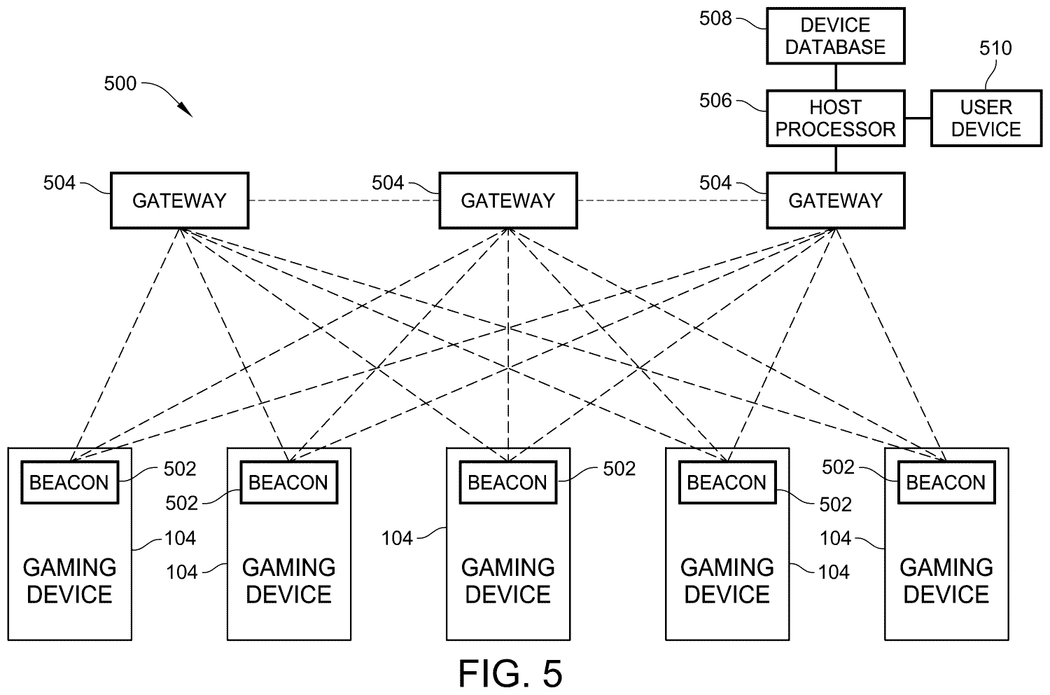

FIG. 5 is a block diagram of an exemplary device management system 500 for electronically tracking gaming devices 104 and sub-components 402. Device management system 500 includes one or more gaming devices 104, which may each include a respective beacon 502. Host system may further include one or more gateways 504 and at least one host processor 506. Beacons 502 and gateways 504 may form a mesh network that enables gaming devices 104 to communicate with host processor 506 (e.g., via beacons 502 and gateways 504). The mesh network may be a wireless mesh network, such as a BLE or UWB mesh network.

In the exemplary embodiment, host processor 506 may be configured to receive device data from each gaming device 104. For example, gaming device 102 may use or communicate with (e.g., wired or wirelessly) beacon 502 to transmit this device data to host processor 506 via the wireless mesh network. Beacon 502 may communicate with host processor 506 directly or through one or more intermediaries such as gateways 504. Because the wireless mesh network offers a greater range than RFID, it is advantageous to user the wireless mesh network to transmit the device data to host processor 506 rather than implementing a direct RFID connection between gaming device 104 and host processor 506.

This device data may include a gaming device identifier associated with each gaming device and any RFID identifiers that have been detected by each gaming device, as described above with respect to FIG. 4. In some embodiments, the gaming device identifier itself may be or may correspond to an RFID identifier (e.g., if an RFID tag 410 is installed on gaming device 104 itself). Using these RFID identifiers, host processor 506 may perform a lookup (e.g., in a device database 508 in communication with host processor 506) to identify any sub-components 402 that are detected and at which gaming device 104 each sub-component 402 is installed. This association between each gaming device 104 and any sub-components 402 detected at each sub-component 402 may be recorded in device database 508.

In the exemplary embodiment, host processor 506 may be configured to determine a location of each gaming device 104. Based on the determined locations of each gaming device 104, host processor may further determine a location of sub-components 402 based on their respective associations with the gaming devices 104. For example, when host processor 506 determines a location of a first gaming device 104, host processor 506 may identify the location of the first gaming device 104 as also being the location of any sub-components 402 installed in the first gaming device 104. This determination may be performed periodically to refresh or update the location of each gaming device 104 and sub-component 402 in device database 508. The rate at which the location is refreshed may vary for each gaming device 104 and sub-component 402. For example, the refresh rate may be increased for a gaming device 104 if it is determined that the gaming device 104 has been moved recently (e.g., within a certain time threshold).

In some embodiments, host processor 506 may determine the location of each gaming device 104 using information retrieved via the mesh network formed by beacons 502 and gateways 504. For example, host processor 506 may determine the location of gaming device 104 using the mesh network based on at least one of triangulation, trilateration, or RSSI.

RSSI uses a signal's power to determine a distance between a receiver and a transmitter (e.g., a beacon 502 and a gateway 504). Wireless signals generally lose power as they propagate. If the original signal strength is known, the distance to the transmitter of the signal can be estimated by the based on the power of the signal when received. This technique provides the benefits of requiring a relatively small amount of hardware to implement.

Distances may estimated using the following formula:

Distance=10((measured Power−RSSI)/(10*n)

Measured Power is a factory-calibrated, read-only constant that indicates what an expected RSSI would be at a distance of one meter to the transmitting device. Combined with RSSI value, it enables estimating the distance between the device and the beacon. The RSSI value is the power of the signal when received at a receiving device. This RSSI value depends on distance and the power of the signal at broadcast. For example, Bluetooth utilizes a broadcasting power value of about 2 to 4 dBm, and the resulting RSSI value generally will be about −26 (for a distance of a few inches) to −100 (for a distance of 40-50 m). N is a constant that may be determined based on environmental factors, and may range, for example between 2 (low strength) to 4 (high strength).

Trilateration is another technique for approximating position (e.g., of beacons 502). Trilateration uses a known distance from at least two fixed points (e.g., positions of gateways 504) in 2D space to calculate the position of an object (e.g., beacons 502). Trilateration requires known points as well as distances to perform the calculation. In this example, known points will be the fixed positioning of gateways 504 and the distances can be approximated using the RSSI distance estimation formula between beacons 502 and the gateways 504.

Triangulation is another technique for calculating a position that relies on a known distance between two measuring apparatuses (e.g., two gateways 504) and the measured angles from those two points to an object (e.g., a beacon 502). In some embodiments, the mesh network (e.g., BLE network) may be capable of detecting these angles using BLE or other wireless technologies. The angle-side-angle triangle congruency theorem enables determining the location of an object based on these detected angles and distances.

Both triangulation and trilateration are techniques that utilize trigonometry. However, while triangulation relies only on angle measurements to locate the unknown point, trilateration uses distance measurements. RSSI utilizes signal strength to estimate distance. Accordingly, a combination of these techniques may be used to accurately determine a location of a beacon 502 and corresponding gaming device 104.

In the exemplary embodiment, host processor 506 may be configured to generate a map including the locations of gaming devices 104 and sub-components 402. Host processor 506 may be in communication with one or more user devices 510, which may execute an application (e.g. a web application or mobile application) that enables host processor to cause user device 510 to display the generated map. Via the application, host processor 506 may further cause user device 510 to display a list of detected gaming devices 104 and/or sub-components 402 and/or other information relating to gaming devices 104 and/or sub-components 402.

In some embodiments, host processor 506 may be configured to determine a location of user device 510. For example, a location of user device user device 510 may be detected using the mesh network as described above and/or using external data, such as global positioning system (GPS) data. In such embodiments, host processor 506 may control or cause a change of a display of gaming device 104 or user device 510 based on a relative position of gaming device 104 to user device 510. For example, in cases in which user device 510 is associated with an operator (e.g., a maintenance worker), the user may input a target gaming device 104 or sub-component 402, and the application may provide directions and/or messages based on a relative position of the target gaming device 104 to user device 510. In another example, user device 510 may correspond to a player, and a location of user device 510 may be used to determine when the player is at a particular gaming device 104. This data may be used, for example, to enable the player to automatically log in to the gaming device 104 and/or for other player tracking purposes.

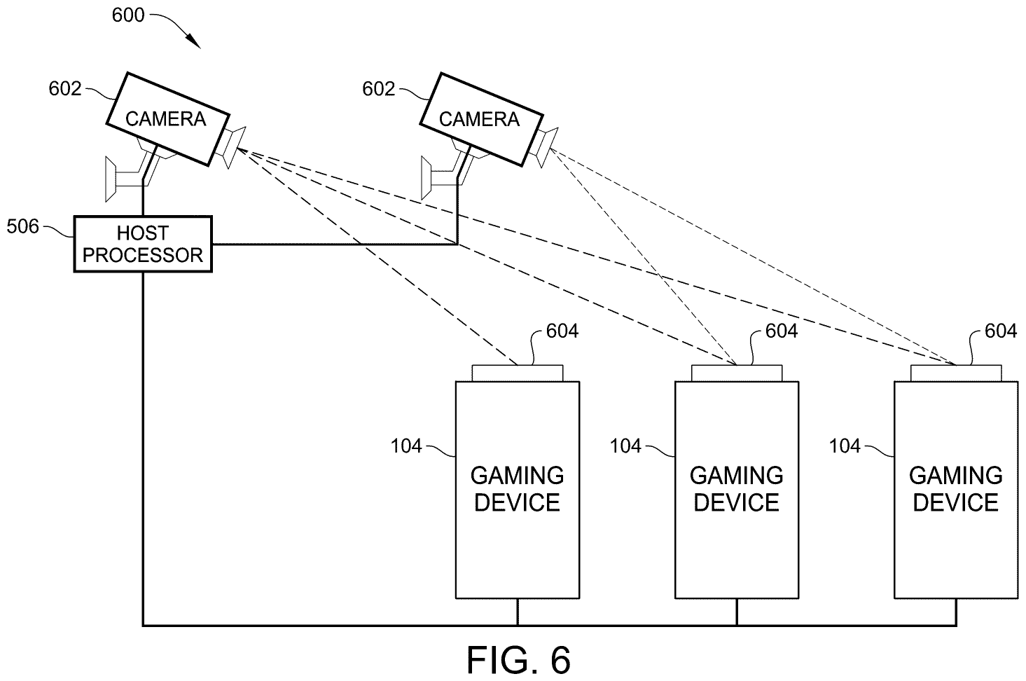

FIG. 6 is a block diagram of an exemplary device management system 600 for electronically tracking gaming devices 104 and sub-components 402. Device management system 600 includes one or more gaming devices 104.

Device management system 600 may further include host processor 506 and one or more cameras 602 in communication with host processor 506. Host processor may generally function as described with respect to FIG. 5, and may utilize camera 602 to determine locations of gaming devices 104. This CV-based system for determining locations of gaming devices 104 may be used alternatively to or in addition to the locating systems described above with respect to FIG. 5.

In the exemplary embodiment depicted in FIG. 6, host processor 506 may be configured to receive image data from camera 602 and determine the location of each gaming device 104 based on the image data. Each gaming device 104 may include at least one visual tag 604 disposed on gaming device 104 that is visible to camera 602. As described in further detail below, visual tags 604 may include letters, numbers, and/or patterns, or some combination thereof, that are detectable by camera 602. In some embodiment, to ensure that all visual tags 604 are visible to at least one camera 602, an array of cameras 602 may be used, or one or more cameras 602 may be capable of moving and/or adjusting in orientation.

Host processor 506 may be configured to determine the location of gaming device 104 based on a detected relative position of the visual tag 604 with respect to camera 602. For example, each visual tag 604 may include an optically-detectable gaming device identifier that is unique to the corresponding gaming device 104, and may further include a predefined pattern from which a distance and orientation of the visual tag 604 from camera 602 can be determined. This distance and orientation can be compared to a known position and orientation of camera 602 to determine a location of the visual tag 604 and corresponding gaming device 104.

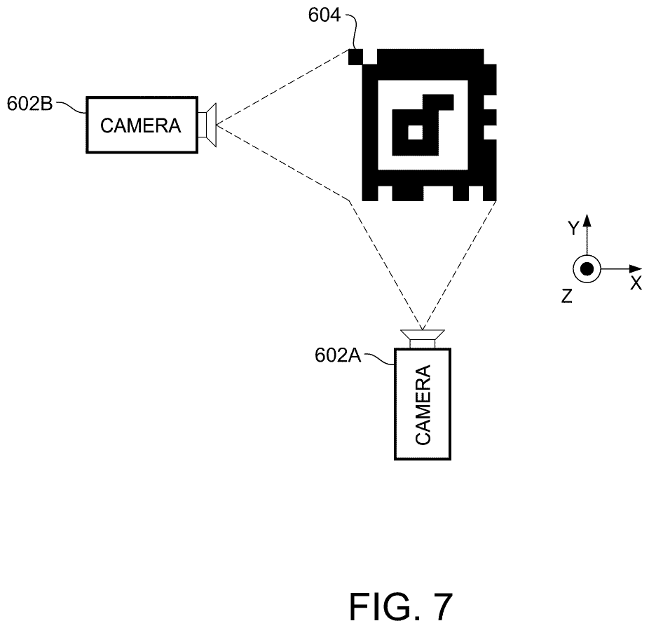

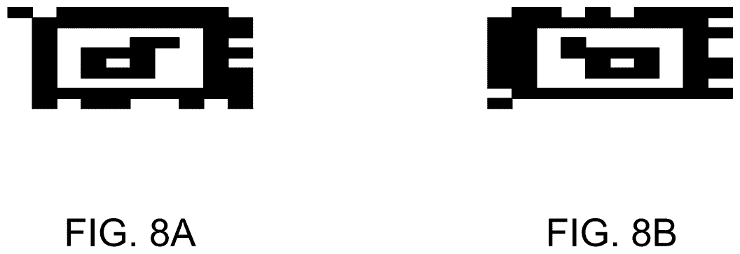

FIG. 7 illustrates an exemplary arrangement in which two cameras 602 (camera 602A and camera 602B) each detect an exemplary visual tag 604 from a respective position. FIG. 8A depicts visual tag 604 as viewed by camera 602A, and FIG. 8B depicts visual tag 604 as viewed by camera 602B. As illustrated by FIGS. 8A and 8B, an orientation of visual tag 604 may appear differently depending the angle from which tag 604 is viewed, while the predefined pattern contained within tag 604 may remain detectable by each camera 602.

For example, the predefined pattern may be configured to enable host processor 506 to identify an x-axis, y-axis, and z-axis (indicated for example in FIG. 7) associated with the visual tag 604. Based on this identified x-axis, y-axis, and z-axis, host processor 506 may determine an orientation and/or angle of visual tag 604 with respect to camera 602 and/or a reference coordinate system, and may estimate a distance between visual tag 604 and camera 602 based on this determined orientation and/or angle. The predefined pattern may further have a predefined size, when enables host processor 506 to determine a distance of visual tag 604 from camera 602 based on an apparent size of the predefined pattern form camera 602.

To uniquely identify gaming devices 104, visual tags 604 may include detection markers containing discernable data that can be captured by camera 602. Examples of such detection markers may include augmented reality (AR) tags or quick response (QR) tags. Host processor 506 may detect these visual tags 604 based on image data received from cameras 602 by scanning unique image attributes that are contained within visual tags 604. Examples of algorithms for detecting corresponding tag patterns include ArUco and Apriltag. Certain pattern designs may include a hole or non-defined area in the center, which in some cases may be used to fit another smaller tag that may convey additional information.

In some embodiments, visual tags 604 may include a small, square piece of paper or plastic with a unique pattern of black and white squares. The pattern may be easily recognizable by cameras 602, even when viewed from different angles and in various lighting conditions. By detecting the pattern contained within a visual tag 604 and analyzing its orientation, host processor 506 can calculate the position and orientation of the visual tag in three dimensional space relative to camera 602. This information can be used to estimate the position of the visual tag 604 and corresponding gaming device 104 relative to the known position of camera 602.

For visual tags 604 to be detectable by camera 602, they must meet a certain resolution threshold. For a given distance between cameras 602 and visual tags 604, tradeoffs exist between a resolution of camera 602 and the required size of visual tags 604 and between a zoom level of cameras 602 (e.g., a higher zoom level reduces the size of visual tags 604 required) and a field of vision (FOV) of cameras 602. Accordingly, for a CV-based location system to be effective in a casino facility, a balance between camera resolution and tag size may be selected that maximizes detection accuracy while ensuring minimal cost and equipment visibility. In some embodiments, motorized cameras 602 with angle and zoom adjustment may be used, which in some cases may lower the count of cameras 602 needed to cover a given floor area.

In some embodiments, host processor 506 may utilize a homography calculation to estimate the relative position of the detected visual tags 604. To perform such a calculation, host processor 506 may first detect key points of visual tag 604 on an image plane. This may be readily performed on AR tags using their detection corresponding algorithms. Once these points are detected, they are compared with corresponding points of the true dimensions of visual tags 604 in real space to generate a pose estimate, which indicates rotation and translation vectors that allow transforming a 3D point expressed in a world frame of reference into the frame of reference of camera 602. These vectors in turn may be used to calculate distances between the detected visual tags 604 and camera 602, and, by setting one of the visual tags 604 as an origin point, each object can be converted into a space defined relative to that visual tag 604 to create a top-down map view of the position of each visual tag 604 and corresponding gaming device 104.

Utilizing cameras 602 to determine a location of gaming devices 104 provides certain advantages. In particular, this technique does not require than any additional computer hardware be installed or connected to gaming devices 104 for real-time location tracking, and requires only that a visual tag 604 be placed on each gaming device 104. Visual tags 604 may be easy to manufacture, such as being printed on paper. In some cases, cameras already existing in a casino environment, such as security cameras, may be leveraged for identifying real-time location of gaming devices 104. Utilizing cameras 602 to determine a location of gaming devices 104 necessitates that all gaming devices 104 be within a field of view of at least one camera 602 within a sufficiently close distance for the camera 602 to resolve any patterns and/or identifiers of the corresponding visual tag 604. For example, the maximum detection distance for a camera 602 may be determined by the formula below:

Max detection distance=t/(2*tan((b*f*p)/(2*r)))In the above equation, t refers to the size of visual tag 604 in meters, or edge length, b refers to a number of bits that span the width of the tag, f refers to a horizontal FOV of camera 602, r refers to a horizontal resolution of camera 602, and p refers to a number of pixels required to detect a bit. This number of pixels is an adjustable constant, where smaller numbers of pixels result in lower read accuracy.

Once host processor 506 has determined a location of gaming devices 104 using camera 602, host processor 506 may determine a location of any sub-components 402 and provide location and mapping functions as described with respect to FIG. 5. Because the embodiment shown in FIG. 6 does not necessarily include a mesh communication network such as that illustrated in FIG. 5, gaming devices 104 and host processor 506 may communicate through a separate wired (e.g., ethernet) or wireless (e.g., Wi-Fi or cellular) communication network so that gaming devices 104 may provide information, such as detected RFID identifiers associated with sub-components 402, to host processor 506.

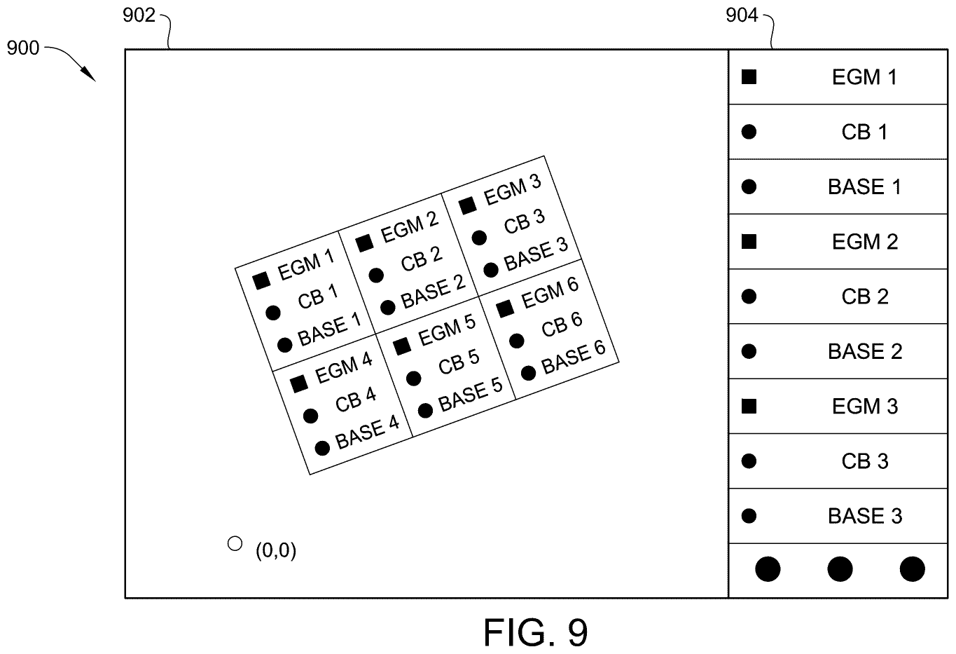

FIG. 9 depicts an example user interface 900 of that may be displayed, for example, by user device 510 based on information received from host processor 506. User interface 900 may include a map 902 and a device list 904.

Map 902 indicates relative positions of various gaming devices (e.g., “EGM 1,” “EGM 2,” “EGM 3,” “EGM 4,” “EGM 5,” and “EGM 6”) and sub-components 402 (e.g., “CB 1,” “CB 2,” “CB 3,” “CB 4,” “CB 5,” “CB 6,” “BASE 1,” “BASE 2,” “BASE 3,” “BASE 4,” “BASE 5,” and “BASE 6”) labeled with corresponding identifiers. In the embodiment shown in FIG. 9, locations of gaming devices 104 are indicated with a square indicator, and locations of sub-components 402 are labeled with circular indicators. In some embodiments, the name and label associated with a particular gaming device 104 or sub-component 402 may be customized or edited via user interface 900. These locations may be shown relative to a floorplan or a reference coordinate system (demarcated by an origin point “(0,0)” in the example shown in FIG. 9), which may be global or correspond to a particular venue. Map 902 may further include a floorplan The locations of gaming devices 104 and sub-components 402 may be determined by and map 902 generated by host processor 506 as described above. In some embodiments, map 902 may further indicate locations of gateways 504, user devices 510, cameras 602, or any other devices in communication with host processor 506.

Device list 904 may include identifiers, corresponding to those shown in map 902, that are associated with each identified gaming device 104 and sub-component 402. As shown in FIG. 9, gaming devices 104 and sub-components 402 may be grouped together within device list 904 based on which gaming device 104 the sub-components are installed. For example, EGM 1, and CB1 and BASE1, which are connected to EGM 1 and located at the same location (e.g., as determined based on RFID), may be displayed within device list 904 consecutively. In some embodiments, each gaming device 104 and sub-component 402 within device list 904 is selectable, which may enable an operator to view or edit information or a status of the selected gaming device 104 and sub-component 402, cause gaming device 104 and sub-component 402 to be shown or hidden within map 902, to initiate a navigation operation in which user interface 900 may highlight and/or provide directions to a selected gaming device 104 and sub-component 402 (e.g., within map 902), to cause lighting or display changes (e.g., illuminating LEDs) on a selected gaming device 104 (e.g., for easier identification) and/or to reconfigure or preform updates (e.g., software of firmware updates) to gaming devices 104.

User interface 900 may further enable a user to configure map 902, device list 904, and/or any devices (e.g., gaming devices 104 and/or sub-components 402). In one example, the user may include a floorplan within map 902. This floorplan configuration function enables the user, via user interface 900, to upload an image as well as set the aspect ratio and origin point of the floorplan coordinate system. The floorplan image to be uploaded may be in, for example, a PNG format. The aspect ratio of the floorplan may match the length and width of the real-world floorplan in meters. An origin for the coordinate system (e.g., the (0,0) point) may also be specified by a user via user interface 900.

Other example functions of user interface 900 may include: (1) hiding offline devices, which may hide display of offline gaming devices 104 and/or associated sub-components 402 within map 902 and/or device list 904; (2) showing or hiding device labels (e.g., “EGM 1”) within map 902; (3) enabling or disabling a position average feature that causes host processor 506 to average measurements overtime to make a more accurate estimate of a device location; (4) capturing a screenshot of map 902; (5) a help button function that selected, causes user interface 900 to display one or more documents containing, for example, detailed information about the system and some frequently asked questions; and/or (5) displaying historical locations or configuration data relating to any gaming devices 104, sub-components 402, beacons 502, gateways 504, and/or other devices in communication with host processor 506. As described above, user interface 900 may be displayed using an application (e.g., a mobile application), which may enable a user to set up different networks (e.g., each corresponding to a respective venue) and/or select between different networks, each having a corresponding map 902 and device list 904.

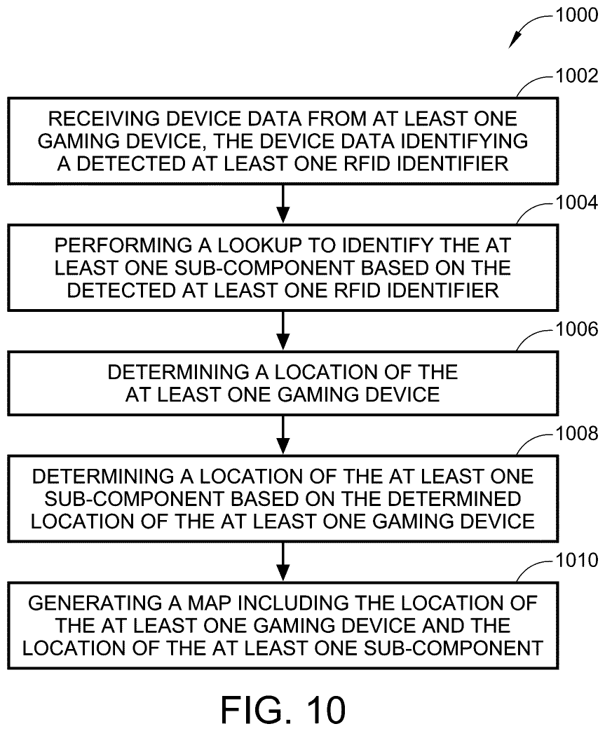

FIG. 10 is a flowchart illustrating an exemplary method 1000 for device management. Method 1000 may be performed by host system including host processor 506, which is in communication with a real-time location system (e.g., including beacons 504, gateways 504, and/or cameras 602), device database 508, and at least one gaming device 104. As described above with respect to FIG. 4, gaming device 104 may include at least one sub-component 402 and an RFID reader 408 configured to detect at least one RFID identifier of at least one RFID tag 410 disposed on sub-component 402.

In the exemplary embodiment, method 1000 may include receiving (block 1002) device data from gaming device 104. The device data may identify the RFID identifier detected using RFID reader 408.

In the exemplary embodiment, method 1000 may further include performing (block 1004) a lookup (e.g., in device database 508) to identify at least one sub-component 402 based on the detected at least one RFID identifier.

In the exemplary embodiment, method 1000 may further include determining (block 1006) a real-time location of gaming device 104 using the real-time locating system. As described above with respect to FIG. 5, in some embodiments, the real-time locating system includes a mesh network formed by beacons 502 and gateways 504 in communication with gaming device 104, and the location of gaming device 104 may be determined based on information retrieved via the mesh network. For example, the mesh network may include at least one of a BLE network or a UWB network, which may be used to determine the location of gaming device 104 using the mesh network based on at least one of triangulation, trilateration, RSSI, and/or some combination thereof. This mesh network may also be used for communication between gaming devices 104 and host processor 506. For example, in some embodiments, the device data may be received from gaming device 104 through the mesh network.

Additionally, or alternatively, as described above with respect to FIG. 6, in some embodiments, the real-time locating system may include at least one camera 602 in communication with host processor 506, which may receive image data from cameras 602 and determine the location of gaming device 104 based on the image data. For example, a visual tag 604 may be disposed on gaming device, and may determine the location of gaming device 104 may be determined based on a detected relative position of visual tag 604 with respect to cameras 602.

In the exemplary embodiment, method 1000 may further include determining (block 1008) a location of sub-components 402 based on the determined location of gaming device 104.

In the exemplary embodiment, method 1000 may further include generating (block 1010) a map (e.g., map 902) including the location of gaming device 104 and the location of sub-components 402. As described above (e.g., with respect to FIGS. 5 and 7), in some embodiments, a user device 510 (e.g., by executing an application) may display the generated map and/or a list (e.g., device list 904) of detected components including gaming device 104 and sub-components 402.

As described above, in some embodiments, a location of user device 510 may be determined. In such embodiments, a display of gaming device 104 or of user device 510 may be controlled based on a relative position of gaming device 104 to user device 510. For example, a user device 510 may enable an operator to easily identify a target gaming device 104 by displaying a message on user device 510 or gaming device 104 when the operator is nearby, or may display promotional messages to a player associated with gaming device 104 or prompt the player to log in to gaming device 104 when the player is nearby.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A device management system comprising:
at least one gaming device comprising at least one sub-component and a radio frequency identification (RFID) reader configured to detect at least one RFID identifier of at least one RFID tag disposed on the at least one sub-component; and
a host system comprising a real-time locating system, at least one processor in communication with the at least one gaming device, with the real-time locating system, and with at least one memory device, the at least one processor configured to:
receive device data from the at least one gaming device, the device data identifying the detected at least one RFID identifier;
perform a lookup to identify the at least one sub-component based on the detected at least one RFID identifier;
determine a real-time location of the at least one gaming device using the real-time locating system;
determine a location of the at least one sub-component based on the determined location of the at least one gaming device; and
generate a map including the real-time location of the at least one gaming device and the location of the at least one sub-component.

2. The device management system of claim 1, wherein the real-time locating system comprises a mesh network in communication with the at least one gaming device, and wherein the at least one processor is configured to determine the real-time location of the at least one gaming device based on information retrieved via the mesh network.

3. The device management system of claim 2, wherein the mesh network is configured to transmit the device data including the at least one RFID identifier from the at least one gaming device to the at least one processor.

4. The device management system of claim 2, wherein the mesh network includes at least one of a Bluetooth low energy (BLE) network or an ultra wide band (UWB) network.

5. The device management system of claim 2, wherein the at least one processor is configured to determine the real-time location of the at least one gaming device using the mesh network based on at least one of triangulation, trilateration, or received signal strength indicator (RSSI).

6. The device management system of claim 1, wherein the real-time locating system comprises at least one camera in communication with the host system, wherein the at least one processor is further configured to:
receive image data from the at least one camera; and
determine the real-time location of the at least one gaming device based on the image data.

7. The device management system of claim 6, further comprising at least one visual tag disposed on the at least one gaming device, wherein the at least one processor is further configured to determine the real-time location of the at least one gaming device based on a detected relative position of the at least one visual tag with respect to the at least one camera.

8. The device management system of claim 1, wherein the at least one processor is further configured to cause a user device to display the generated map.

9. The device management system of claim 1, wherein the at least one processor is further configured to cause a user device to display a list of detected components including the at least one gaming device and the at least one sub-component.

10. The device management system of claim 1, wherein the at least one processor is further configured to determine a location of at least one user device.

11. The device management system of claim 10, wherein the at least one processor is further configured to control a display of at least one of the at least one gaming device or the at least one user device based on a relative position of the at least one gaming device to the at least one user device.

12. A host system for a device management system, the host system comprising a real-time locating system, at least one processor in communication with at least one memory device, the real-time locating system, and at least one gaming device, the at least one gaming device including at least one sub-component and a radio frequency identification (RFID) reader configured to detect at least one RFID identifier of at least one RFID tag disposed on the at least one sub-component, the at least one processor configured to:
receive device data from the at least one gaming device, the device data identifying the detected at least one RFID identifier;
perform a lookup to identify the at least one sub-component based on the detected at least one RFID identifier;
determine a real-time location of the at least one gaming device using the real-time locating system;
determine a location of the at least one sub-component based on the determined real-time location of the at least one gaming device; and
generate a map including the real-time location of the at least one gaming device and the location of the at least one sub-component.

13. The host system of claim 12, wherein the real-time locating system comprises a mesh network in communication with the at least one gaming device, and wherein the at least one processor is configured to determine the real-time location of the at least one gaming device based on information retrieved via the mesh network.

14. The host system of claim 13, wherein the mesh network is configured to transmit the device data including the RFID identifier from the at least one gaming device to the at least one processor.

15. The host system of claim 13, wherein the mesh network includes at least one of a Bluetooth low energy (BLE) network or an ultra wide band (UWB) network.

16. The host system of claim 13, wherein the at least one processor is configured to determine the real-time location of the at least one gaming device using the mesh network based on at least one of triangulation, trilateration, or received signal strength indicator (RSSI).

17. The host system of claim 12, wherein the real-time locating system comprises at least one camera in communication with the at least one processor, wherein the at least one processor is further configured to:
receive image data from the at least one camera; and
determine the real-time location of the at least one gaming device based on the image data.

18. The host system of claim 17, wherein at least one visual tag is disposed on the at least one gaming device, and wherein the at least one processor is further configured to determine the real-time location of the at least one gaming device based on a detected relative position of the at least one visual tag with respect to the at least one camera.

19. The host system of claim 12, wherein the at least one processor is further configured to cause a user device to display the generated map.

20. A method for device management, the method performed by a host system including a real-time locating system and at least one processor in communication with at least one memory device, the real-time locating system, and at least one gaming device, the at least one gaming device including at least one sub-component and a radio frequency identification (RFID) reader configured to detect at least one RFID identifier of at least one RFID tag disposed on the at least one sub-component, the method comprising:
receiving device data from the at least one gaming device, the device data identifying the detected at least one RFID identifier;
performing a lookup to identify the at least one sub-component based on the detected at least one RFID identifier;
determining a real-time location of the at least one gaming device using the real-time locating system;
determining a location of the at least one sub-component based on the determined real-time location of the at least one gaming device; and
generating a map including the real-time location of the at least one gaming device and the location of the at least one sub-component.
